(19) United States
(12) Patent Application Publication
(10) Pub. No.: US 2026/0252223 A1
(43) Pub. Date: Aug. 27, 2026

(54) SYSTEMS AND METHODS FOR GENERATING AND DISPLAYING AN INTERACTIVE USER INTERFACE

(71) Applicant: rewardStyle, Inc., Dallas, TX (US)

(72) Inventors: Oliver DSOUZA, Sammamish, WA (US); Baxter BOX, Dallas, TX (US); Leonardo Yaz Huckins CILMI, Sausalito, CA (US); Rebecca NISSEN, San Diego, CA (US)

(73) Assignee: rewardStyle, Inc., Dallas, TX (US)

(21) Appl. No.: 19/547,307

(22) Filed: Feb. 23, 2026

Related U.S. Application Data
(60) Provisional application No. 63/762,430, filed on Feb. 24, 2025.

(51) Int. Cl. G06F 3/04845; G06F 3/04842

(52) U.S. Cl. CPC G06F 3/04845; G06F 3/04842

(57) ABSTRACT

A method may include generating a first user interface (“UI”) element including a set of geographic elements (“GEs”), wherein each of the set of GEs represents a respective selectable filter, only a subset of the set of GEs may be presented in a UI at a time, and the set of GEs may rotate in a first direction within the UI in response to a first input. The method may also include generating a second UI element including a set of interest elements (“IEs”), wherein each of the set of IEs represents a respective selectable filter, only a subset of the set of IEs may be presented in the UI at a time, the set of IEs may rotate in the first direction within the UI in response to a second input, and the second UI element may be positioned proximate to the first UI element in the UI.

### CROSS-REFERENCE TO RELATED APPLICATION

This application claims the benefit of priority from U.S. Provisional Application No. 63/762,430, filed February 24, 2025, which is incorporated by refence herein in its entirety.

### TECHNICAL FIELD

The present invention relates generally to generating and displaying an interactive user interface and, more specifically, to systems and methods for generating and displaying an interactive user interface that includes selectable filters associated with one or more videos that may be presented in the interactive user interface.

### BACKGROUND

Consumers often visit online platforms (e.g., social media networks, websites, portals, applications, or the like) to view content, explore interests, follow creators, and/or shop for items or services. However, online platforms often include or support algorithms that move consumers away from the content the consumers wish to view or explore in depth (e.g., content produced by particular creators). Even when online platforms provide personalized or recommended content to a consumer, such content may hinder the consumer’s ability to view content that is actually of interest to the consumer.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for generating and displaying an interactive user interface that includes selectable filters associated with one or more videos that may be presented in the interactive user interface, are disclosed. Each of the examples disclosed herein may include one or more features described in connection with any of the other disclosed examples.

A computer-implemented method may include generating, using a computing device, a first user interface element including a set of geographic elements, wherein each of the set of geographic elements represents a respective selectable filter, wherein only a subset of the set of geographic elements is configured to be presented in a user interface at a time, and wherein the set of geographic elements is configured to rotate in a first direction within the user interface in response to a first input associated with the first user interface element. The method may also include generating, using the computing device, a second user interface element including a set of interest elements, wherein each of the set of interest elements represents a respective selectable filter, wherein only a subset of the set of interest elements is configured to be presented in the user interface at a time, wherein the set of interest elements is configured to rotate in the first direction within the user interface in response to a second input associated with the second user interface element, and wherein the second user interface element is configured to be positioned proximate to the first user interface element in the user interface.

A computing system may include one or more processors and one or more non-transitory computer readable media having programming instructions stored thereon, which, when executed by the one or more processors, cause the computing system to perform operations. The operations may include generating a first user interface element including a set of geographic elements, wherein each of the set of geographic elements represents a respective selectable filter, wherein only a subset of the set of geographic elements is configured to be presented in a user interface at a time, and wherein the set of geographic elements is configured to rotate in a first direction within the user interface in response to a first input associated with the first user interface element. The operation may also include generating a second user interface element including a set of interest elements, wherein each of the set of interest elements represents a respective selectable filter, wherein only a subset of the set of interest elements is configured to be presented in the user interface at a time, wherein the set of interest elements is configured to rotate in the first direction within the user interface in response to a second input associated with the second user interface element, and wherein the second user interface element is configured to be positioned proximate to the first user interface element in the user interface.

A computer-implemented method may include generating, using a computing system, a user interface element including a set of geographic elements, wherein each of the set of geographic elements represents a respective selectable filter, wherein only a subset of the set of geographic elements is configured to be presented in a user interface at a time, and wherein the set of geographic elements is configured to rotate in a direction within the user interface in response to an input associated with the user interface element, the user interface being configured to include a video stream. The method may also include, in response to receiving, by the computing system, a selection of a geographic element of the set of geographic elements, determining, by the computing system, one or more videos associated with the selected geographic element to present in the video stream.

### BRIEF DESCRIPTION OF THE DRAWINGS

The present invention will be more fully understood by reference to the following detailed description of the preferred embodiments of the present invention when read in conjunction with the accompanying drawings, wherein:

FIG. 1 illustrates an environment, according to one or more embodiments.

FIG. 2 illustrates an example user interface, according to one or more embodiments.

FIG. 3 illustrates an example user interface, according to one or more embodiments.

FIG. 4 illustrates an example user interface, according to one or more embodiments.

FIG. 5 illustrates an example user interface, according to one or more embodiments.

FIG. 6 illustrates an example user interface, according to one or more embodiments.

FIG. 7 illustrates example content for training a machine learning model, according to one or more embodiments.

FIG. 8 illustrates a flowchart of an example method for generating and displaying a user interface, according to one or more embodiments.

FIG. 9 illustrates a flow diagram for training a machine learning model, according to one or more embodiments.

FIG. 10 illustrates an example computing device, according to one or more embodiments.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF EMBODIMENTS

Oftentimes, consumers visit online platforms (e.g., social media networks, websites, portals, applications, or the like) to view and/or search for content aligned with the consumers’ interests, to follow creators, and/or to shop for products or services. Yet many online platforms include or support algorithms that divert consumers away from content the consumers wish to explore in depth, such as content related to the consumers’ favorite locations or interests. Additionally, the user interfaces of many search platforms are not optimized for intuitive navigation, making it difficult for users to apply criteria or filters to refine search results effectively. Accordingly, there is a need for a search platform and user interface that provide consumers with greater control over the content they wish to access in a seamless and user-friendly manner.

Aspects of the present disclosure provide systems and methods for generating and displaying an interactive user interface of an online platform (e.g., a social media network, website, portal, application, or the like) that provides a consumer with greater control over content the consumer may wish to view via the online platform, relative to existing online platforms. For example, aspects of the present disclosure provide a method for generating and displaying a user interface that includes a video feed (e.g., of videos representing digital media posts), and a first user interface element and a second user interface element that may be overlaid on the video. In some embodiments, the first user interface element and the second user interface element may be positioned proximate to one another in the user interface. In some aspects, the first user interface element may include a set of geographic elements, where only a subset of the set of geographic elements may be presented in the user interface at a given time. Each of the set of geographic elements may represent, for example, a name of a region or location. In some aspects, the set of geographic elements may be configured to move or rotate (e.g., like a dial or carousel) in response to a user input associated with the set of geographic elements, so that the user may scroll through each of the set of geographic elements. Further, each of the set of geographic elements may represent a selectable filter and be associated with one or more videos. For example, a geographic element of the set of geographic elements, that represents Miami, may be associated with one or more videos that were recorded in (or otherwise related to) Miami. When a user selects the geographic element representing Miami, the one or more videos recorded in Miami may be presented in the video feed.

The second user interface element may include a set of interest elements, where only a subset of the set of interest elements may appear in the user interface at a given time. Each of the set of interest elements may represent, for example, an interest area or category. In some aspects, the set of interest elements may be configured to move or rotate (e.g., like a dial or carousel) in response to a user input associated with the set of interest elements, so that the user may scroll through each of the set of interest elements. Further, each of the set of interest elements may represent a selectable filter and be associated with one or more videos. For example, an interest element of the set of interest elements, that represents fashion, may be associated with one or more videos related to fashion (e.g., one or more videos that depict apparel). When a user selects the interest element representing fashion, the one or more videos related to fashion may be presented in the video feed.

In some aspects, the user may select one or more of the geographic elements of the set of geographic elements, and/or one or more of the interest elements of the set of interest elements. In some embodiments, where a user selects both a geographic element of the set of geographic elements and an interest element of the set of interest elements, one or more videos that were recorded in (or otherwise related to) the region associated with the selected geographic element and that are related to the selected interest element may be presented in the user interface.

Embodiments of the present disclosure provide significant technical benefits and advantages over conventional approaches in the field of user interfaces for online platforms. For example, while conventional online platforms may channel a user away from content the user wishes to explore in depth, embodiments described herein provide a user interface for an online platform that allows a user to control the content of a video feed presented in the user interface, so that the user can focus on content of greatest interest to the user. For example, the user may use one or more user interface elements of the user interface to filter the content of the video feed based on location(s) and/or interest area(s). Moreover, relative to existing human-machine interfaces, the user interface elements described herein allow a user to easily and intuitively scroll through various filters to rapidly access content of interest to the user, thereby providing an improved user experience. For additional examples, please see paragraphs [0037]-[0041] and [0047]-[0054] herein.

A system and method are described herein for generating and displaying an interactive user interface that includes selectable filters associated with one or more videos that may be presented in the interactive user interface. The system and method may be practiced on one or more networked computing devices. As used herein, the term “automated computing device” or “computing device” or “computing device platform” means a device capable of executing program instructions as streamed or as requested from attached volatile or non-volatile memory. For example, such a device utilizes a microprocessor, microcontroller, or digital signal processor in signal communication with a dedicated and/or shared memory component (RAM, ROM, etc.), one or more network components (NIC, Wi-Fi, Bluetooth, Zigbee, etc.), one or more user input components (keyboard, mouse, touchscreen, etc.), one or more user output or display components, and/or additional peripheral components including a database for bulk data storage. The computing device may also utilize a standard operating system upon which the program instructions may be executed (OS X, iOS, Linux, UNIX, Android, Windows, etc.) or may utilize a proprietary operating system for providing basic input/output. For purposes of illustration but not limitation, examples of a computing device include mainframe computers, workstation computers, database servers, personal computers, laptop computers, notebook computers, tablet computers, smartphones, personal digital assistants (PDAs), or the like, or even some combination thereof.

As used herein “computer readable medium” means any tangible portable or fixed RAM or ROM device, such as portable flash memory, a CDROM, a DVDROM, embedded RAM or ROM integrated circuit devices, or the like. A “data storage device” or “database device” means a device capable of persistent storage of digital data, for example, a computer database server or other computing device operating a relational database management system (RDBMS), for example, SQL, MySQL, Apache Cassandra, or the like, or even a flat file system as commonly understood.

As used herein, the term “network” or “computer network” means any digital communications network that allows computing devices to exchange data over wired and/or wireless connections, including the telecommunications infrastructure. Such a network also allows for distributed processing, for example, through website and database hosting over multiple computer network connected computing devices. The present invention may utilize one or more such networked computing devices, with each device physically residing in different remote locations, including in the “cloud” (i.e., cloud computing). As used herein, the term “online” means, with respect to a computing device, that the computing device is in computer network communication with one or more additional computing devices. The term “online” means, with respect to a user of a computing device, that the user is utilizing the computing device to access one or more additional computing devices over a computer network.

As used herein, the term “computer network address” or “network address” means the uniform resource identifier (URI) or unique network address by which a networked computer may be accessed by another. The URI may be a uniform resource locator (URL), a uniform resource name (URN), or both, as those terms are commonly understood by one of ordinary skill in the information technology industry.

As used herein, the term “web browser” means any software application for retrieving, presenting, or traversing digital information over a network (e.g., Safari, Firefox, Netscape, Internet Explorer, Chrome, and the like). A web browser accepts as an input a network address, and provides a page display of the information available at that network address. Underlying functionality includes the ability to execute program code, for example, JavaScript or the like, to allow the computing device to interact with a website at a given network address to which the browser has been “pointed.”

As used herein, the term “digital media” means any form of electronic media where media data are stored in digital format. This includes, but is not limited to, video, still images, animations, audio, any combination thereof, and the like. The term “rank” or “ranking” of the digital media means the assignment of a value by one viewing the digital media that indicates the one's approval or disapproval, or acceptance, of the digital media. For example, most social media network services allow a user viewing a posted digital media to indicate whether the viewer “likes” the posted digital media by allowing the selection of a “like” button (or other such graphical user input device) associated with the digital media. The social media network service records and persists this “like” ranking in a dedicated database as a use metric, associating the ranking with the posted digital media and attributing the ranking with the member user. Also collected as a metric by social media network services are the digital media views by the member users. Thus, an inference may be made that a user that views a particular digital media without assigning a “like” ranking either does not like the digital media or is ambivalent towards the particular digital media. In addition to or alternatively, social media network services may allow a value ranking by, for example, allowing a member user to assign a multiple star value (e.g., 0 to 5 stars) or a number range (e.g., 0 to 10), with the higher star count or number range indicating a greater or lesser approval or acceptance of the digital media.

The method steps and computing device interaction described herein are achieved through programming of the computing devices using commonly known and understood programming means. For example, stored programs consisting of electronic instructions compiled from high-level and/or low-level software code using industry standard compilers and programming languages, or may be achieved through use of common scripting languages and appropriate interpreters. The method steps operating on user computing devices may utilize any combination of such programming language and scripting language. For example, compiled languages include BASIC, C, C++, C#, Objective-C, .NET, Visual Basic, and the like, while interpreted languages include JavaScript, Perl, PHP, Python, Ruby, VBScript, and the like. For network communications between devices, especially over internet TCP/IP connections, web browser applications and the like may use any suitable combination of programming and scripting languages, and may exchange data using data interchange formats, for example, XML, JSON, SOAP, REST, and the like. One of ordinary skill in the art will understand and appreciate how such programming and scripting languages are utilized with regard to creating software code executable on a computing device platform.

As used herein, the term “machine learning model” may generally encompass instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data (e.g., experiential data or samples of input data), which are fed into the model in order to establish, tune, or modify one or more aspects of the model (e.g., the weights, biases, criteria for forming classifications or clusters, or the like). Aspects of a machine learning model may operate on an input linearly, in parallel, via a network (e.g., a neural network), or via any suitable configuration.

The execution of the machine learning model may include deployment of one or more machine learning techniques, such as a neural network(s), convolutional neural network(s), regional convolutional neural network(s), mask regional convolutional neural network(s), transformer(s), vision transformer(s), deformable detection transformer(s), linear regression, logistical regression, random forest, gradient boosted machine (GBM), deep learning, or a deep neural network. Supervised or unsupervised training may be employed. For example, supervised learning may include providing training data and labels corresponding to the training data as, for example, ground truth. Unsupervised approaches may include clustering, classification, or the like. Any suitable type of training may be used (e.g., stochastic, gradient boosted, random seeded, recursive, epoch or batch-based, etc.). In some embodiments, a machine learning technique (e.g., a machine learning model, methodology, or algorithm) may be selected and executed or deployed based on the volume of data to be processed using the machine learning technique and the computing resources available.

In some embodiments, a machine learning model may be trained using Contrastive Language-Image Pre-Training (“CLIP”). CLIP refers to a method for efficiently training a pair of machine learning models (e.g., neural network models) contrastively (e.g., to learn relationships between inputs to the pair of machine learning models). In some aspects, the pair of machine learning models may represent a pair of sub-machine learning models that are included in a single machine learning model (where a sub-machine learning model may also be referred to herein as a “sub-model”) For example, a single machine learning model may include a first sub-model (e.g., an image encoder) and a second sub-model (e.g., a text encoder). Using CLIP, the first sub-model may be trained to understand images (or image data), the second sub-model may be trained to understand text (or text data), and the first and second sub-models may be trained to learn relationships between the images and text (e.g., a contrastive objective). More specifically, in some embodiments, and using CLIP, (i) the first sub-model may receive an image (e.g., depicting a dress), and may output a vector including one or more numerical values that represent the visual content of the image, where the vector may be stored; (ii) the second sub-model may receive text (e.g., the phrase, “an evening dinner dress”), and may output a vector including one or more numerical values that represent the semantic content of the text, where the vector may be stored; and (iii) the first and second sub-models (or the single machine learning model) may be trained to further output a score that represents the degree of similarity between the image and the text (e.g., score representing a high degree of similarity between the image depicting a dress and the phrase “an evening dinner dress,” where the score may be stored).

In some other embodiments, and using CLIP, (i) the first sub-model may receive an image, map the image to a vector that includes one or more numerical values that represent the visual content of the image, and output the vector; (ii) the second sub-model may receive text representing multiple phrases (or sentences or descriptions), map the text to a vector that includes one or more numerical values that represent the semantic content of the text, and output the vector; and (iii) the first and second sub-models (or the single machine learning model) may be trained to further output a vector that includes multiple scores, where each of the multiple scores represents a respective degree of similarity between the image and a respective phrase of the text. In such embodiments, as an alternative to outputting a vector that includes multiple scores, the first and second sub-models (or the single machine learning model) may output an indication of which phrase (or phrases) are the most similar to the image.

As used herein, a vector output from a sub-model trained using CLIP may also be referred to as an “embedding,” and may represent a signature or identifier of data (e.g., image data or text data) input to the sub-model. Further, in some aspects, the numerical values of the vector may be mathematically computed using, for example, addition or subtraction. In some embodiments, a vector output from a sub-model trained using CLIP (e.g., the first sub-model or the second sub-model) may include a high number of numerical values (e.g., hundreds or thousands or numerical values), and thus represent a high dimensional space. In some aspects, a vector output from the first sub-model and a vector output from the second sub-model can be visualized as points (or nodes) in a high-dimensional graph, and the distance between the two vectors may represent the degree of similarity between the two vectors.

As used herein, a machine learning model trained using CLIP may also be referred to as a “CLIP model” or a “joint image and text embedding model.” In some aspects, a CLIP model may be pre-trained using 400 million image-text pairs, where each image text pair represents an image and text retrieved from the internet. Further, the CLIP model may be pre-trained using natural language supervision. In some aspects, a CLIP model may be used for a variety of applications. For example, a CLIP model may be used for one or more of image classification (e.g., categorizing an image, optionally without using specific labels); visual searching (e.g., identifying image(s) that are relevant to a text query provided to the CLIP model); image-text matching (e.g., identifying text description(s) that are relevant to an image input to the CLIP model); or zero-shot learning (e.g., identifying new objects or concepts represented in an image based on textual descriptions available on the internet), among other applications.

In the following description, embodiments will be described with reference to the accompanying drawings. As will be discussed in more detail below, various embodiments, methods, and systems for generating and displaying an interactive user interface are described.

In an exemplary use case, a consumer may plan to travel to New York City to attend a fashion show. To prepare for the trip, the consumer may wish to learn more about current fashion trends in New York City. To access such information, the consumer may use a laptop to log into a social media network service to which the consumer subscribes. The consumer may subsequently view a user interface of the social media network service, where the user interface includes a video feed. The user interface may also include a first user interface element overlaid on the video feed, where the first user interface element includes a set to geographic elements. Each of the set of geographic elements may represent the name of a region or location (e.g., Miami, Dallas, New York City, Los Angeles, Chicago). However, only a subset of the set of geographic elements may appear on the user interface at a given time. Thus, the consumer may initially see, for example, Miami, Dallas, and New York City indicated as geographic elements of the first user interface element. In some aspects, the user may wish to explore more of the geographic elements included in the set of geographic elements by selecting the first user interface element and dragging the first user interface element in a first direction (e.g., to a side of the user interface). The set of geographic elements may be configured to move or rotate (like a dial or carousel) in response to the user’s input. Thus, while the user drags the first user interface element in the first direction, the geographic element representing Miami may disappear from one side of the user interface, but the geographic element representing Los Angeles may appear on the other side of the user interface. In some aspects, each of the set of geographic elements may represent a selectable filter.

The user interface may also include a second user interface element overlaid on the video feed and positioned proximate to (e.g., immediately below) the first user interface element. The second user interface element may include a set of interest elements, where each of the set of interest elements may represent an interest or category (e.g., fashion trends, makeup, home décor, travel, running). However, only a subset of the set of interest elements may appear on the user interface at a given time. Thus, the consumer may initially see, for example, fashion, makeup, and home décor indicated as interest elements of the second user interface element. In some aspects, the subset of the set of interest elements may be configured to move or rotate in a manner similar to that described above with respect to the set of geographic elements. Further, each of the set of interest elements may represent a selectable filter.

The consumer may wish to view videos in the video feed that relate to New York City and fashion trends, and to do so, the user may select the geographic element representing New York City and the interest element representing fashion trends. As a result, videos recorded (or filmed) in New York City and relating to fashion trends may be presented in the video feed of the user interface. In some embodiments, one or more of the videos presented in the video feed may include items (e.g., clothing) that the consumer can purchase. In some other embodiments, none of the videos presented in the video feed may include items (e.g., clothing) that the consumer can purchase.

In some aspects, the consumer can use the first and second user interface elements to control the content of the video feed and readily access videos that are relevant to the consumer (e.g., videos that were filmed in New York City and relate to fashion trends). As a result, the user interface may be used to provide an immersive video experience that includes high quality content. Moreover, relative to existing online platforms, the user interface may increase the consumer’s confidence and engagement with the videos. The user interface may also allow the consumer to focus on content provided by creators that the consumer follows and trusts.

While the example above involves a geographic element representing New York City and an interest element representing fashion trends, it should be understood that techniques according to this disclosure may be adapted to any suitable geographic element or interest element. It should also be understood that the example above is illustrative only. The techniques and technologies of this disclosure may be adapted to any suitable activity.

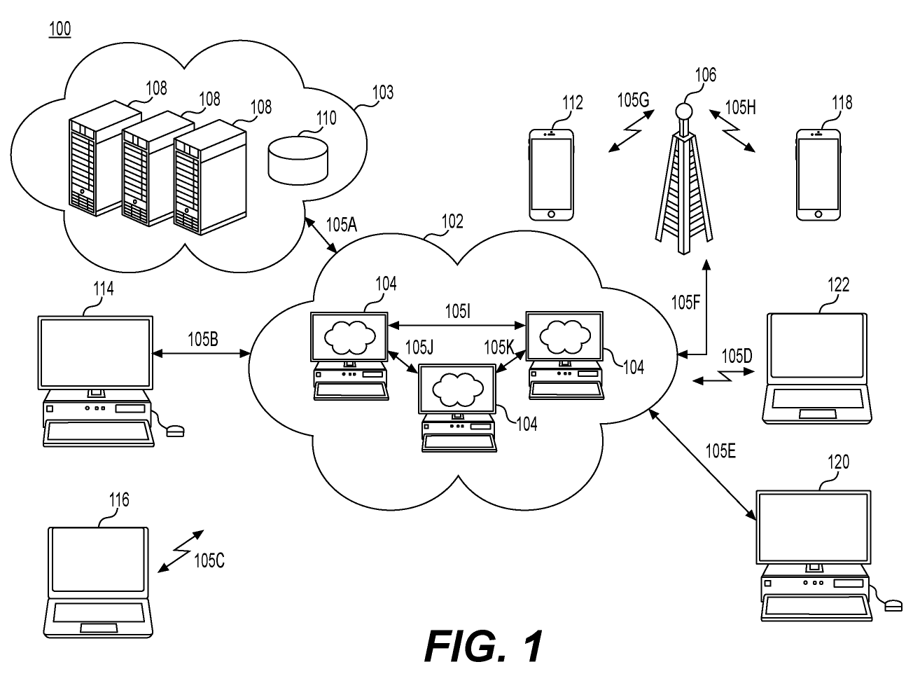

FIG. 1 depicts an environment 100, according to one or more embodiments. In some aspects, the environment 100 may represent a hardware and network architecture that may be used to practice one or more of the embodiments described herein. As shown in FIG. 1, the environment 100 may include a computer network 102, devices 103, computing systems 104, 112, 114, 116, 118, 120, and 120, and cellular network(s) 106. As shown in FIG. 1, the computing systems 104, 114, and 120 may represent desktop computers, the computing systems 108 (also referred to herein as the “devices 108”) may represent servers, the computing systems 116 and 122 may represent laptops, and the computing systems 112 and 118 may represent mobile devices. However, in some aspects, each of the computing systems 104, 112, 114, 116, 118, 120, and 120 may represent any of a server, a workstation, a desktop computer, a laptop, a mobile device, a tablet, or the like. In some aspects, each of the devices 103, and each of the computing systems 112, 118, 114, 116, 118, 120, and 122 may be configured to communicate with the computer network 102 via a network connection (e.g., a wired network connection, a wireless network connection, an internet connection, or the like). That is, the devices 103 may communicate with the computer network 102 via a network connection 105A (e.g., a wired network connection); the computing system 114 may communicate with the computer network 102 via a network connection 105B (e.g., a wired connection); the computing system 116 may communicate with the computer network 102 via a network connection 105C (e.g., a wireless connection); the computing system 120 may communicate with the computer network 102 via a network connection 105E (e.g., a wired connection); and the computing system 122 may communicate with the computer network 102 via a network connection 105D (e.g., a wireless connection). The computing system 112 may communicate with the cellular network(s) 106 via a network connection 105G (e.g., a wireless connection), and the cellular network(s) 106 may communicate with the computer network 102 via a network connection 105F (e.g., a wired connection). In some aspects, the computing system 112 may communicate with the computer network 102 via the network connection 105G, the cellular network(s) 106, and the network connection 105F. The computing system 118 may communicate with the cellular network(s) 106 via a network connection 105H. In some aspects, the computing system 118 may communicate with the computer network 102 via the network connection 105H, the cellular network(s) 106, and the network connection 105F.

As shown in FIG. 1, the computer network 102 may include the computing systems 104, which may communicate with one another via network connections 105I, 105J, and 105K. In some aspects, one or more of the network connections 105I, 105J, and 105K may represent a wired network connection, a wireless network connection, an internet connection, or the like. In some embodiments, the computer network 102 (e.g., the computing systems 104) may be associated with (e.g., owned, controlled, rented, or operated by) one or more entities (e.g., organizations, companies, social media network services, or the like). For example, the computing systems 104 may be associated with one or more companies or social media network services such as LTK, retailers, Instagram, Facebook, Twitter, Pinterest, Google+, Tumblr, YouTube, Vine, and Flicker. In some aspects, such companies or social media network services may be configured to accept or receive, by the computing systems 104, digital media (e.g., posts of digital media or social media posts). In some embodiments, where the computing systems 104 are associated with one or more social media network services, the computing systems 104 may operate or provide services by executing stored program software code, and may afford third-party access to such services through an application programming interface (“API”). For example, the Instagram API may allow registered third-party access to posted digital media, captions and related metadata (including “likes” of the posted digital media), real-time digital media updates, and other data, available on or via the computing systems 104 (e.g., using API calls). In some embodiments, the computing systems 104 may be configured to receive, store, train, re-train, deploy, or transmit one or more machine learning models (e.g., a CLIP model).

In some aspects, the devices 103 may be associated with (e.g., owned, controlled, rented, or operated by) an entity (e.g., an organization, company or the like). In some embodiments, the devices 103 and the computing systems 104 may be associated with the same entity. In some other embodiments, the devices 103 may be associated with an entity that is different than the entity associated with the computing systems 104. As shown in FIG. 1, the devices 103 may include computing systems 108 and storage device(s) 110. In some embodiments, operations described herein may be performed using (or by) one or more of the computing systems 108 or the storage device(s) 110, depending on various requirements or constraints. For example, operations described herein may be performed using one or more of the computing systems 108 or the storage device(s) 110 depending on the number of computing systems 108 and/or storage device(s) 110 available; the computing power available from the computing systems 108; the amount of storage space available in the storage device(s) 110; budgetary constraints associated with the computing systems 104 and the storage device(s) 110; a number of actual or anticipated users of the computing systems 104 and the storage device(s) 110; failover of the computing systems 108; or redundancy for continuity of service of the computing systems 104 or the storage device(s) 110. In some embodiments, the computing systems 108 or the storage device(s) 110 may be configured to access services or data from the computing systems 104 via API calls. Further, in some embodiments, the computing systems 108 or the storage device(s) 110 may be configured to receive, store, train, re-train, deploy, or transmit one or more machine learning models (e.g., a CLIP model).

In some embodiments, one or more of the computing systems 112, 114 and 116 may be associated with (e.g., owned, controlled, rented, or operated by) one or more creators (or influencers or publishers). For example, a creator may use the computing system 114 to create and/or store one or more digital media posts, and transmit the one or more digital media posts to the computer network 102 via the network connection 105B. In some cases, the creator may transmit the one or more digital media posts from the computing system 114 to the devices 103 via the network connection 105B, the computer network 102, and the network connection 105A. In some embodiments, where the computer network 102 is associated with a social media network service, and where the computer network 102 receives the one or more digital media posts from the computing system 114, the computer network 102 may make the one or more digital media posts accessible to subscribers (or members) of the social media network service, such that the subscribers may be able to review, browse, rank, copy, download, or share the one or more digital media posts. Further, in some embodiments, the subscribers may be able to purchase one or more items or services represented in the one or more digital media posts (e.g., using tools incorporated in or associated with the one or more digital media posts).

In some embodiments, one or more of the computing systems 118, 120, and 122 may be associated with one or more users, consumers, or subscribers (or members) of the social media network service or other entity associated with the computer network 102. For example, a user associated with the computing system 120 may be a subscriber of a social media network service associated with the computer network 102, and the user may use the computing system 120 to access, from the computer network 102, one or more digital media posts offered by the social media network.

In some embodiments, the computing system 120 (or the computing system 118 or 122) may be configured to generate one or more user interfaces associated with the social media network service (or other entity associated with the computer network 102 and/or an entity associated with the devices 108). The computing system 120 may also be configured to display the one or more user interfaces (e.g., using a website, webpage, web portal, or application, or the like) on a display screen associated with the computing system 120. In some aspects, each of the one or more user interfaces may be interactive and configured to include a respective video feed (e.g., one or more videos representing digital media posts). For example, a user interface may include a first user interface element (or control element) that includes a set of geographic elements, where each of the geographic elements may represent a selectable filter. In some aspects, only a subset of the set of geographic elements may be included or presented in the user interface at a given time. For example, where the set of geographic elements includes 10 geographic elements, only 5 geographic elements of the set of 10 geographic elements may be displayed in the user interface at a given time. In some aspects, the 5 geographic elements may represent any 5 geographic elements of the set of 10 geographic elements. However, in some aspects, the set of geographic elements may be configured to rotate (e.g., like a dial or carousel) in a first direction in response to the user providing an input to the computing system 120. For example, where a user uses a mouse associated with the computing system 120 to click and drag (or the user’s finger to touch and drag/scroll), in the first direction, the subset of the set of geographic elements presented in the user interface, the subset of the set of geographic elements may move in the first direction such that at least some of the subset of the set of geographic elements begin to disappear (or disappear entirely) from the user interface from the perspective of the user, while at least some other geographic elements of the set of geographic elements begin to appear (appear entirely) in the user interface from the perspective of the user. In some embodiments, the set of geographic elements may be configured to rotate (e.g., like a dial or carousel) in a second direction, opposite the first direction, in response to the user providing a different input to the computing system 120.

In some embodiments, one or more geographic elements of the set of geographic elements may represent (e.g., using text data) a location, geographic region, city, state, country, or the like. Further, in some embodiments, a geographic element of the set of geographic elements may represent multiple (or all) locations, geographic regions, cities, states, countries, or the like. In some embodiments, one of the geographic elements of the set of geographic elements may represent a location of the computing system 120. Further, in some aspects, each geographic element of the set of geographic elements may be associated with one or more videos. For example, where a geographic element represents a location (e.g., New York City), each of the one or more videos associated with the geographic element (i) may have been filmed or recorded in, or may be live-streamed from, New York City, and (ii) may include metadata that references New York City (e.g., as a latitude and longitude). In some embodiments, the computing system 120 may be configured to analyze one or more videos (e.g., digital media posts) received from the computer network 102 to determine which of the one or more videos include metadata that references New York City (or another location), and should thus be associated with the geographic element representing New York City (or another location). In some other embodiments, the computing system 120 may retrieve one or more videos that include metadata that references New York City (or another location) from the computer network 102 (or the devices 108), in response to the user selecting the geographic element that represents New York City (or another location). Further, in some aspects, the computer network 102, the devices 108, and/or the computing system 120 may analyze metadata of one or more videos, extract location(s) referenced in the metadata, store the extracted location(s) as latitude(s) and longitude(s) (e.g., in the storage device(s) 110). The computer network 102, the devices 108, and/or the computing system 120 may subsequently reverse geocode the stored location(s) into human-readable location(s), and/or determine one or more geographic elements to include in the set of geographic elements based on the stored (and optionally reverse geocoded) location(s). Further, in some embodiments, the computer network 102, the devices 108, and/or the computing system 120 may determine

As explained above, in some embodiments, one of the geographic elements of the set of geographic elements may represent a location (e.g., a current location) of the computing system 120 (or effectively a location of a user of the computing system 120). In such embodiments, the geographic element may be represented as “Near Me” (e.g., text data) in the user interface. Further, in some aspects, the geographic element may be associated with one or more pre-defined (or threshold) distances or radii (or one or more distance or radii filters), that are relative to the location of the computing system 120. For example, the geographic element may be associated with predefined distances (or radii) of 50 miles, 100 miles, 150 miles, or the like, as measured from the location of the computing system 120. Further, the geographic element may be associated with one or more videos that were recorded or filmed within one or more of the predefined distances (or radii). Further, in some embodiments, the computing system 120 may be configured to determine whether a threshold number (e.g., a minimum number) of videos were recorded or filmed (or are being live-streamed) within the shortest pre-defined distance (or radii). For example, the computing system 120 may transmit a query to the computer network 102 and/or the devices 108 for a determination as to whether the threshold number of videos recorded within the shortest predefined distance exists and may thus be retrieved and included in the video feed of the user interface. If the threshold number of videos exists within the shortest predefined distance (e.g., where the user of the computing system 120 is located in a densely populated area in which many creators create videos as digital media posts), the computer network 102 and/or the devices 108 may aggregate and transmit the threshold number of videos to the computing system 120 for inclusion in the video feed. However, if the threshold number of videos does not exist within the shortest predefined distance (e.g., where the user of the computing system 120 is located in a sparsely populated area in which few or no creators create videos as digital media posts), the computer network 102 and/or the devices 108 may notify the computing system 120 accordingly. In such case, the computing system 120 may transmit another query to the computer network 102 and/or the devices 108 for a determination as to whether the threshold number of videos recorded within the second shortest predefined distance exists and may thus be retrieved and included in the video feed of the user interface. If the threshold number of videos recorded within the second shortest predefined distance exists, the computer network 102 and/or the devices 108 may aggregate and transmit the threshold number of videos to the computing system 120 for inclusion in the video feed. However, if the threshold number of videos recorded within the second shortest predefined distance does not exist, the computer network 102 and/or the devices 108 may notify the computing system 120 accordingly. In such case, the computing system 120 may transmit another query to the computer network 102 and/or the devices 108 for a determination as to whether the threshold number of videos recorded within the third shortest predefined distance exists and thus may be retrieved and included in the video feed of the user interface, and the computer network 102 and/or the devices 108 may respond in an appropriate manner as described above. This process may continue in a similar fashion until a threshold number of videos recorded within a predefined distance of the computing system 120 is determined to exist by the computer network 102 and/or the devices 108, which may then aggregate and transmit the threshold number of videos to the computing system 120 for inclusion in the video feed. As a result, the user may view a threshold number of videos recorded near, or closest to, the location of the computing system 120 (and thus effectively the location of the user).

In some embodiments, the user interface may include a second user interface element (or control element) that includes a set of interest (or category) elements, where each of the interest elements may represent a selectable filter. In some aspects, only a subset of the set of interest elements may be included or presented in the user interface at a given time. For example, where the set of interest elements includes 10 interest elements, only 5 interest elements may be displayed in the user interface at a given time. However, in some aspects, the set of interest elements may be configured to rotate (e.g., like a dial or carousel) in a first direction in response to the user providing a second input to the computing system 120. For example, where a user uses a mouse associated with the computing system 120 to click and drag (or, in the case of a mobile device or a computing system utilizing a touch screen, the user’s finger to touch and drag/scroll), in the first direction, the subset of the set of interest elements presented in the user interface, the subset of the set of interest elements may move in the first direction such that at least some of the subset of the set of interest elements begin to disappear (or disappear entirely) from the user interface from the perspective of the user, while at least some other interest elements of the set of interest elements begin to appear (or appear entirely) in the user interface from the perspective of the user. In some embodiments, the set of interest elements may be configured to rotate (e.g., like a dial or carousel) in a second direction, opposite the first direction, in response to the user providing a different input to the computing system 120. In some embodiments, the second user interface element may be positioned proximate to (e.g., adjacent or near) the first user interface element in the user interface.

In some embodiments, one or more interest elements of the set of interest elements may represent (e.g., using text data) an interest or category such as running, activewear, casual wear, winter fashion, spring fashion, summer fashion, fall fashion, luxury fashion, deals, trending, holiday, travel, beauty, makeup, hair care, or the like. In some embodiments, an interest element of the set of interest elements may represent multiple (or all) interests or categories. In some aspects, each interest element of the set of interest elements may be associated with one or more videos. For example, where an interest element represents running, one or more videos related to running may be associated with the interest element.

In some aspects, the computing system 120 may include one or more machine learning algorithms or a machine learning model, such as a CLIP model. In some embodiments, the CLIP model may be configured to determine (or pre-define) an order or sequence in which the subset of the set of interest elements is to appear in the user interface based on, for example, behavior of the user (e.g., videos that the user has previously watched, videos or other digital media posts that the user has previously liked, or creators that the user follows). In addition or in the alternative, the CLIP model may be configured to determine (or pre-define) an order or sequence in which multiple videos (e.g., associated with one or more interest elements and/or geographic elements) are to be presented in the video feed of the user interface, based on behavior of the user and/or behavior of other users (e.g., videos watched, content liked, content shared, creators, followed, or the like). In some aspects, to determine (or pre-define) an order or sequence in which multiple videos (e.g., associated with one or more interest elements and/or geographic elements) are to be presented in the video feed of the user interface, the CLIP model may determine one or more scores for the multiple videos. For example, the CLIP model may determine a score (rank) for a video of the multiple videos based on the number of times the video has been liked, shared, or viewed (e.g., by the user or other users). Further, in some embodiments, the CLIP model may determine an order or sequence for the multiple videos to be included in the video feed of the user interface such that the video(s) of the multiple videos that are most likely to be engaging to the user (e.g., most relevant to the “filters” selected by the user) are presented first in the video feed.

In some aspects, the CLIP model may be trained for multiple applications using, for example, one or more of the computer network 102 and/or the devices 103. In some embodiments, the CLIP model may be trained to classify or categorize one or more objects or items (e.g., dresses, shirts, makeup, leggings, or the like), or services, represented or depicted in one or more video frames (or a cover video frame) of a video. Further, in some aspects, the CLIP model may represent a pre-trained model that may be fine-tuned (e.g., retrained or post-trained using supervised learning during a post-creation process) using the computer network 102 and/or the devices 103, and based on receiving, as input, a curated dataset. In some embodiments, the curated dataset may include images (e.g., cover video frames, other videos frames, or other images) that depict or are associated with one or more interests (e.g., fashion, beauty, running, or the like) or more granular categories. Each respective image of the curated dataset may include or be associated with one or more labels (or tags or captions) that reference the interest(s) or other categories represented in (or associated with) the respective image. In some aspects, the curated dataset may be configured to increase the accuracy of the CLIP model (or output(s) of the CLIP model). Further, in some embodiments, the CLIP model may be trained to determine (or output an identification of) one or more videos that are associated with (e.g., relate, are relevant to, are similar to, or contain content that is identical to) one or more interests that are input to the CLIP model. In some embodiments, one or more interests and/or one or more videos (e.g., classified or unclassified videos) may be stored by the computer network 102 and/or the devices 103 (e.g., the storage device(s) 110). Further, in some embodiments, the computing system 120, the computer network 102, and/or the devices 103 may be configured to query the stored one or more interests and/or one or more videos (e.g., to identify or retrieve one or more interests, one or more videos, one or more interests that are associated with one or more videos, or one or more videos that are associated with one or more interests). In some embodiments, the CLIP model may be trained to determine (or output an identification of) one or more interests that are associated with one or more videos that are input to the CLIP model. Further, the CLIP model may be trained to determine (or output an identification of) one or more videos that are associated with one or more interests that are input to the CLIP model.

In some aspects, during a backfill phase, the computer network 102 and/or the devices 103 may be configured to automatically query storage devices therein periodically (e.g., every 24 hours) to identify and retrieve digital media posts (e.g., videos) created by creators during a predetermined time period (e.g., the last 30 days). For example, the computer network 102 and/or the devices 103 may be configured to query the storage devices therein every 24 hours to identify and retrieve videos created by creators during the last 30 days, using, for example, cover video images and/or captions associated with the videos. In some embodiments, after digital media posts (e.g., videos) are identified and retrieved, the computer network 102, the devices 103, and/or the computing system 120 may use the CLIP model to determine what interest(s) with which the digital media posts are associated, and what stages of a sales funnel (e.g., upper funnel, mid funnel, or lower funnel) with which the digital media posts are associated. In some aspects, such determinations may be stored using the computer network 102 and/or the devices 103 (e.g., the storage device(s) 110), and may be subsequently included in a video feed of a user interface.

Although depicted as separate components in FIG. 1, it should be understood that a component or portion of a component in the environment 100 may, in some embodiments, be integrated with or incorporated into one or more other components. For example, in some embodiments, at least a portion of the devices 108 may be incorporated in the computer network 102. In some embodiments, operations or aspects of one or more of the components discussed above may be distributed amongst one or more other components. Any suitable arrangement or integration of the various systems and devices of the environment 100 may be used.

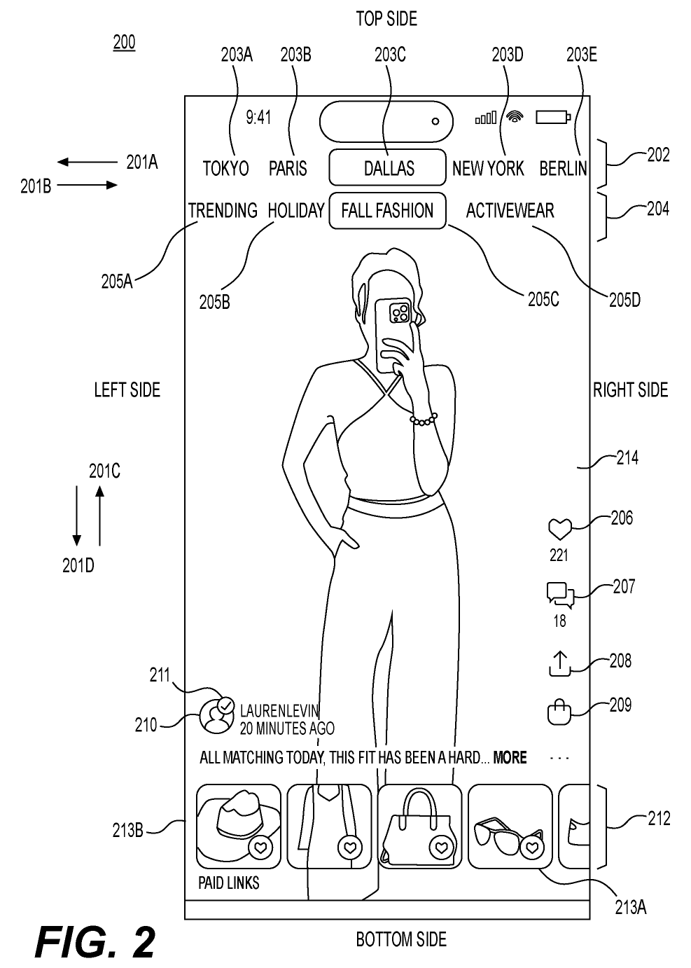

FIG. 2 illustrates an example user interface 200, according to one or more embodiments. In some aspects, the user interface 200 may be presented to a user or other individual using the computing system 120 (or the computing systems 118 or 122). As shown in FIG. 2, the user interface 200 may include a first user interface element 202, which may include a set of geographic elements. In some aspects, only a subset of the set of geographic elements is depicted in the user interface 200. That is, only the geographic element 203A (e.g., Tokyo), the geographic element 203B (e.g., Paris), the geographic element 203C (e.g., Dallas), the geographic element 203D (e.g., New York), and the geographic element 203E (e.g., Berlin) are presented in the user interface 200. However, where a user uses a mouse and cursor (or the user’s finger) to select and move (or rotate) the first user interface element 202 in a first direction 201A, the geographic element 203A (e.g., Tokyo) may begin to disappear from the user interface 200, the geographic element 203E (e.g., Berlin) may fully appear in the user interface 200, and one or more other geographic elements of the set of geographic elements may begin to appear on the right side of the user interface 200. If the user continues to drag the set of geographic elements in the first direction 201A, the geographic element 203 (e.g., Tokyo) will eventually begin to appear on the right side of the user interface 200, followed by the geographic element 203B (e.g., Paris), the geographic element 203C (e.g., Dallas) and so forth. Accordingly, the set of geographic elements may move or rotate (like a dial or carousel) while the user drags the set of geographic elements in the first direction 201A. Where the user drags the set of geographic elements in a second direction 201B (e.g., opposite the first direction 201A), the set of geographic elements may begin to move toward the right side of the user interface 200. For example, the geographic element 203E (e.g., Berlin) may begin to disappear on the right side of the user interface 200, while one or more other geographic elements of the set of geographic elements begins to appear on the left side of the user interface 200.

The user interface 200 may also include a second user interface element 204, which may include a set of interest elements. In some aspects, only a subset of the set of interest elements is depicted in the user interface 200. That is, only the interest element 205A (e.g., Trending), the interest element 205B (e.g., Holiday), the interest element 205C (e.g., Fall Fashion), and the interest element 205D (e.g., Activewear) are presented in the user interface 200. In some aspects, the set of interest elements may be configured to move or rotate in response to an input from a user, in a manner similar to that described above with reference to the set of geographic elements.

As shown in FIG. 2, the first user interface element 202 and the second user interface element 204 may be positioned proximate to one another, and may be overlaid on a video 214. In some aspects, the video 214 may represent one of multiple videos included in a video feed of the user interface 200. For example, where a user uses a mouse and cursor (or the user’s finger) to drag the video 214 in a third direction 201C, the video 214 may begin to move toward the top side of the user interface 200 and disappear, while another video begins to appear from the bottom side of the user interface 200. Conversely, where the user uses a mouse and cursor (or the user’s finger) to drag the video 214 in a fourth direction 201D (opposite the third direction 201C), the video 214 may begin to move toward the bottom side of the user interface 200 and disappear, while another video begins to appear from the top side of the user interface 200. In some aspects, the video 214 may represent a digital media post created by a creator associated with one of the computing systems 112, 114, or 116. Further, in some embodiments, the video 214 and one or more (or all) other videos included in the video feed may represent vertical videos (e.g., videos in a portrait orientation, or videos in which the height of video frames is greater than the width of video frames).

In some embodiments, the video 214 may depict, represent, or be associated with one or more items that may be purchased by a user interacting with the user interface 200. For example, as shown in FIG. 2, the video 214 may include (or be associated with) product images 212, which may be overlaid on the video 214. The product images 212 may include, for example, a product image 213A (e.g., a pair of sunglasses) and a product image 213B (e.g., a cowboy hat), among other product images. In some embodiments, the product images 212 may be configured to move or rotate (like a dial or carousel) in response to a user input, and in a manner similar to that described above with reference to the first and second user interface elements 202 and 204. As shown in FIG. 2, in some embodiments, each product image of the product images 212 may include an icon including a heart, which a user may select to indicate that the user loves or likes the product featured in a respective product image. In some embodiments, such an indication may be saved (e.g., by the computing system 120, the computer network 102, or the devices 103). Further, in some embodiments, each product image of the product images 212 may be selectable and may be associated with a link (e.g., a hyperlink). For example, when a user selects the product image 213A, the user may be directed, via a hyperlink, to a website of a retailer where the user may purchase the pair of sunglasses depicted in the product image 213A. In some embodiments, where the user uses a mouse and cursor (or the user’s finger) to select and hold a portion of the video 214 (e.g., the floor depicted in the video 214), the product images 212 may disappear or fade away so that the user can see the portion of the video 214 that was covered by the product images 212.

Further, as shown in FIG. 2, the video 214 may include an image 210, which may represent, for example, a portrait of the creator who created the video 214. The video 214 may also include a check mark 211 over part of the image 210, where the check mark may represent that the user is following the creator of the video 214. The video 214 may also include one or more other selectable icons, such as the heart icon 206, the comment icon 207, the upload (or download) icon 208, and the shopping icon 209. In some embodiments, the user may select the heart icon 206 to indicate that the user loves or like the video 214, and the user may select the comment icon 207 to provide a comment on the video 214 (using the user interface 200). The user may select the upload (or download) icon 208 to transmit or share the video 214. Further, in some embodiments, the user may select the shopping icon 209 (which may include or be associated with a hyperlink to a retailer’s website), so that the user can be directed to a retailer’s website where the user can purchase one or more items depicted in the video 214.

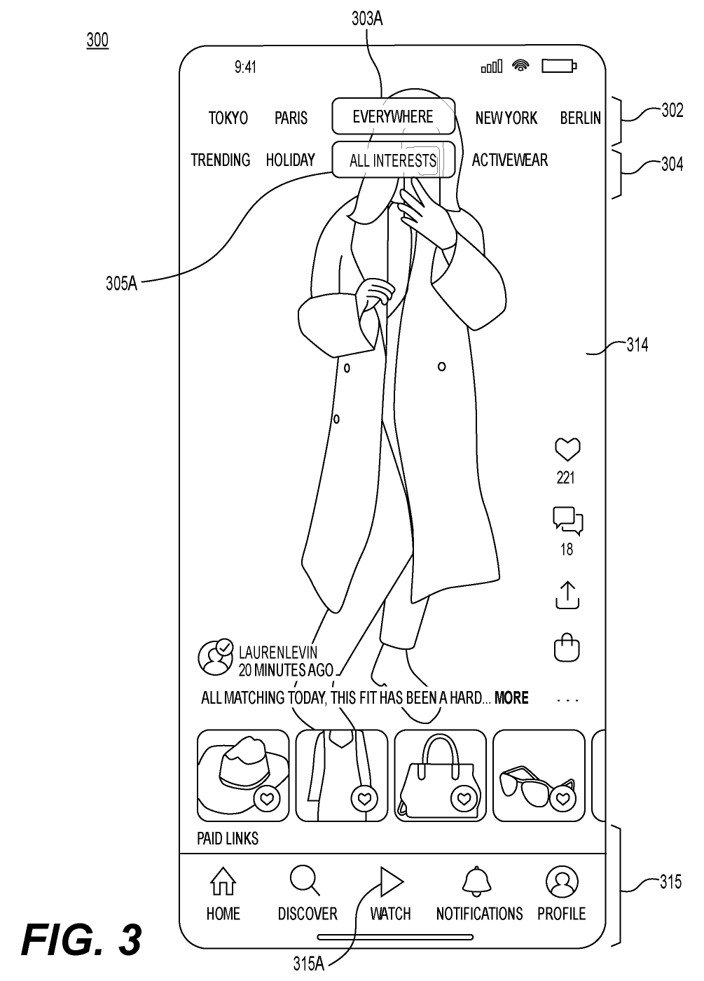

FIG. 3 illustrates an example user interface 300, according to one or more embodiments. In some aspects, the user interface 300 may be an embodiment of the user interface 200. As shown in FIG. 3, the user interface 300 may include a first user interface element 302, which may include a set of geographic elements. In some embodiments, the set of geographic elements may include a geographic element 303A (e.g., Everywhere), which may represent all locations associated with videos that may be included in the video feed of the user interface 300. The user interface 300 may also include a second user interface element 304, which may include a set of interest elements. In some embodiments, the set of interest elements may include an interest element 305A (e.g., All Interests), which may represent all interests (e.g., all categories) associated with videos that may be included in the video feed of the user interface 300.

As shown in FIG. 3, the first user interface element 302 and the second user interface element 304 may be overlaid on a video 314. Further, the user interface 300 may include a menu 315 that includes a set of selectable icons (or buttons). For example, the menu 315 may include a watch button 315A which a user may select to play the video 314.

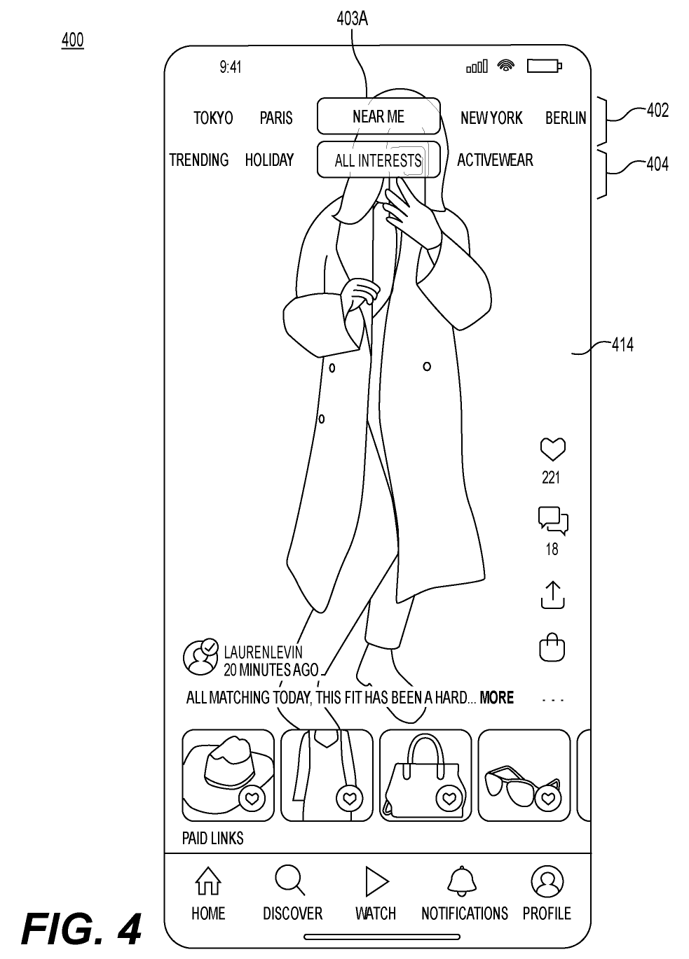

FIG. 4 illustrates an example user interface 400, according to one or more embodiments. In some aspects, the user interface 400 may be an embodiment of the user interfaces 200 and 300, of FIGS. 2 and 3, respectively. As shown in FIG. 4, the user interface 400 may include a first user interface element 402. The first user interface element 402 may include a set of geographic elements. In some embodiments, the set of geographic elements may include a geographic element 403A (e.g., Near Me). The geographic element 403A may be associated with a current location of a computing system (e.g., the computing system 120, 118, or 122) on which the user interface 400 is displayed. As shown in FIG. 4, the user interface 400 may also include a second user interface element 404, which may include a set of interest elements. In some embodiments, the first user interface element 502 and the second user interface element 504 may be overlaid on a video 414 included in a video feed of the user interface 400.

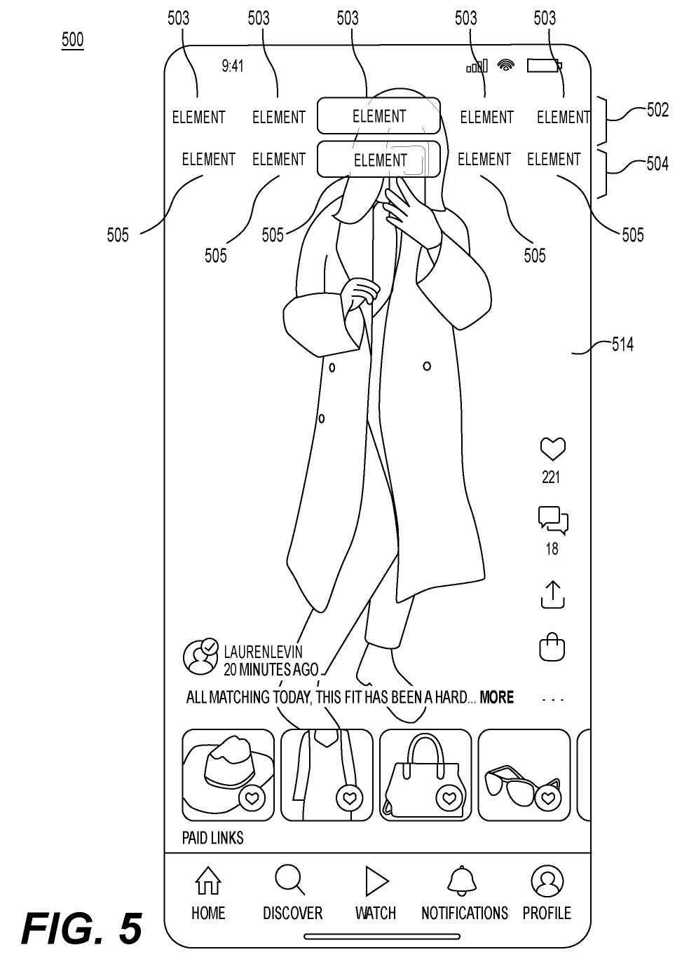

FIG. 5 illustrates an example user interface 500, according to one or more embodiments. In some aspects, the user interface 500 may be an embodiment of the user interfaces 200, 300, and 400, of FIGS. 2, 3 and 4, respectively. As shown in FIG. 5, the user interface 500 may include a first user interface element 502. The first user interface element 502 may include a first set of elements, where only a subset of the first set of elements may be presented in the user interface 500 at a given time. In some embodiments, the first set of elements may include elements 503, where each of the elements 503 represents a respective selectable filter that is associated with one or more videos (or digital media posts). Further, each of the elements 503 may represent a respective category, class, topic, entity, or the like, that is presented in the user interface 500 as text data, image data, or video data. As shown in FIG. 5, the user interface 500 may also include a second user interface element 504, which may include a second set of elements. In some aspects, only a subset of the second set of elements may be presented in the user interface 500 at a given time. In some embodiments, the second set of elements may include elements 505, where each of the elements 505 represents a respective selectable filter that is associated with one or more videos (or digital media posts). Further, each of the elements 505 may represent a respective category, class, topic, entity, or the like, that is presented in the user interface 500 as text data, image data, or video data. In some embodiments, the first user interface element 502 and the second user interface element 504 may be overlaid on a video 514 included in a video feed of the user interface 500.

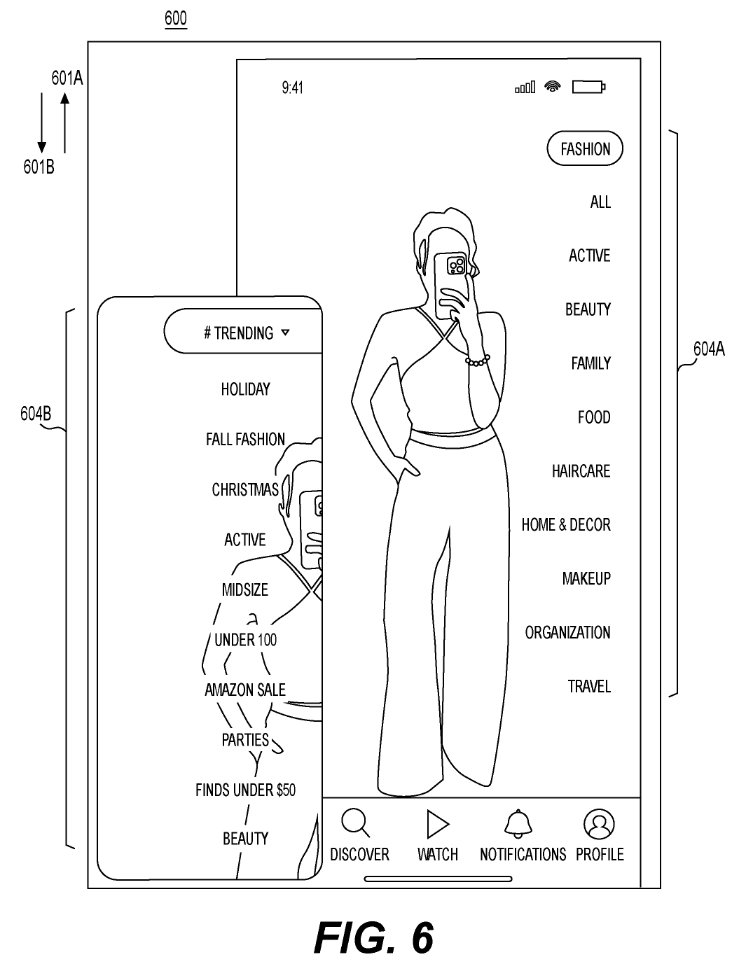

FIG. 6 illustrates an example user interface 600, according to one or more embodiments. In some aspects, the user interface 600 may be an embodiment of the user interfaces 200, 300, 400, or 500 of FIGS. 2, 3, 4, and 5, respectively. As shown in FIG. 6, the user interface 600 may include a user interface element 604A. In some embodiments, the user interface element 604A may be an embodiment of the second user interface element 204, 304, 404, or 504 of FIGS. 2, 3, 4, and 5, respectively. In some aspects, the user interface element 604A may include a set of interest elements (e.g., Fashion, All, Active, Beauty, Family, Food, Haircare, Home & Décor, Makeup, Organization, and Travel). As shown in FIG. 6, in some embodiments, each interest element of the set of interest elements may be presented vertically (or parallel to directions 601A and 601B) in the user interface 600. In some embodiments, only a subset of the set of interest elements may be presented in the user interface 600 at a time. In such embodiments, a user may use a mouse and cursor (or the user’s finger) to move or rotate (like a dial or carousel) the user interface element 604A in the direction 601A or the direction 601B. In some aspects, in addition or in the alternative to the user interface element 604A, the user interface 600 may include a user interface element 604B. As shown in FIG. 6, the user interface element 604B may include a set of interest elements (e.g., Holiday, Fall fashion, Active, Midsize, Under 100, Amazon sale, Parties, finds under $50, Beauty, among others) that fall under a specific category (e.g., Trending). The user interface element 604B may allow the user to select a specific category such as, e.g., Trending, to view the interest elements that are relevant to the category. By selecting the down arrow button shown in the category portion of the user interface element 604B, the user may be able to view other categories that are selectable. Other example categories may include, but not be limited to, Newest, Most Popular, Recommended for You, Top Rated, Most Viewed, Creator’s Picks, Features, Rising Stars, Local Favorites, Most discussed, Timeless, Following, Hidden Gems, Deal & Discounts, Viral, Recently Viewed, etc. In some embodiments, the user interface element 604B may initially present only the Trending interest element, which may represent a drop-down menu. Where a user selects the Trending interest element, the following interest elements may subsequently appear in the user interface element 604B (or drop down from the Trending interest element): Holiday, Fall fashion, Christmas, Active, Midsize, Under 100, Amazon sale, Parties, and Finds under $50, Beauty, optionally among other interest elements. Further, in some embodiments, a user may select one or more interest elements of the user interface element 604B for inclusion in the user interface element 604A (e.g., where the resulting user interface element 604A may be rotated like a carousel in the direction 601A or the direction 601B, or as depicted in previous FIGS. 2-5).

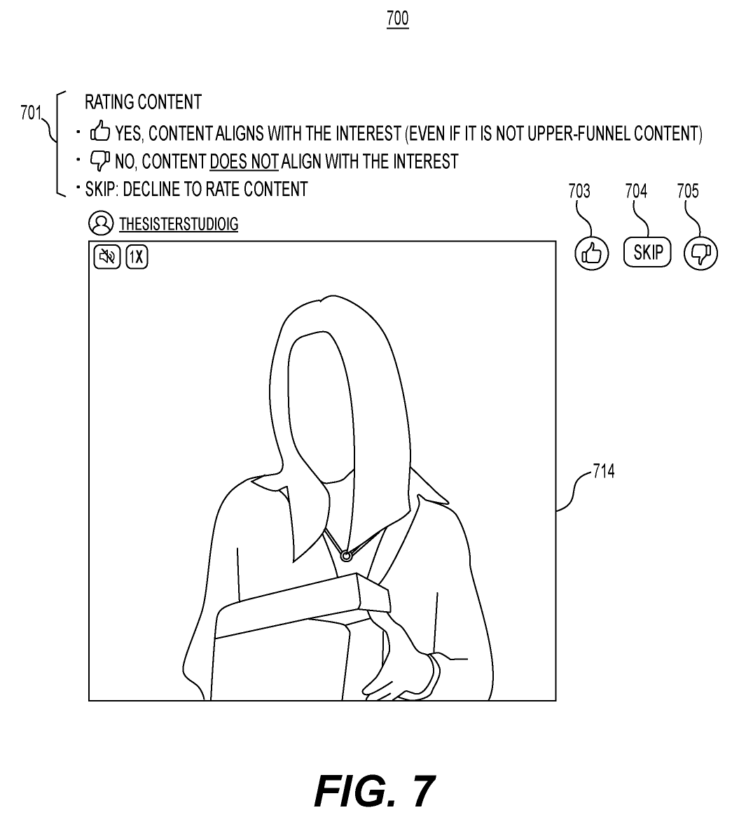

FIG. 7 illustrates example content 700 for training a machine learning model, according to one or more embodiments. In some aspects, the content 700 may be content with which an employee (e.g., of an entity associated with the computer network 102 or the devices 103) interacts in order to train a CLIP model. As shown in FIG. 7, the content 700 may include text 701, a video 714, and buttons 703, 704, and 705. The text 701 may include instructions regarding how the employee may indicate whether the video 714 is aligned (or associated) with a particular interest. In some aspects, the employee may select (i) the button 703 to indicate that the video 714 is aligned with the particular interest, (ii) the button 704 to skip the evaluation of the video 714, or (iii) the button 705 to indicate that the video 714 is not aligned with the particular interest. In some aspects, the content 700 may be used to label content to train a modified version of the CLIP model suited for various use cases (e.g., use cases described herein). Alternatively or in addition, the content 700 may be used to evaluate the accuracy of the CLIP model before a launch or deployment of the CLIP model.

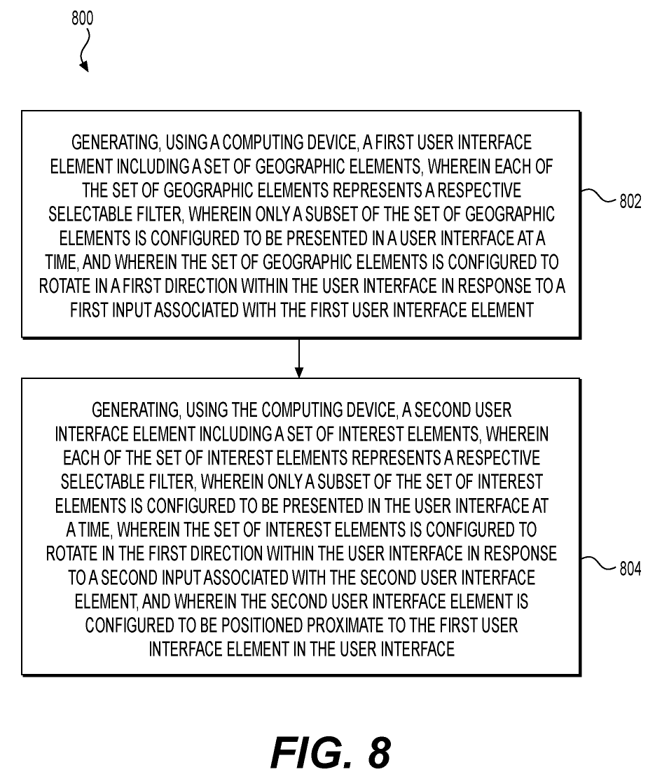

FIG. 8 illustrates a flowchart of an example method 800 for generating and displaying a user interface, according to one or more embodiments. In some embodiments, the method 800 may be a computer-implemented method performed by the computing system 118, 120, or 122 of FIG. 1. Further, the user interface may be an embodiment of the user interface 200, 300, 400, or 500 of FIGS. 2-5, respectively.

As shown in FIG. 8, the method 800 may include generating, using a computing system (e.g., the computing system 120), a first user interface element including a set of geographic elements, wherein each of the set of geographic elements represents a respective selectable filter, wherein only a subset of the set of geographic elements is configured to be presented in a user interface at a time, and wherein the set of geographic elements is configured to rotate in a first direction within the user interface in response to a first input associated with the first user interface element (802). In some aspects, the user interface may be configured to include a video stream (e.g., a video feed). Further, the set of geographic elements may be configured to rotate in a second direction, opposite the first direction, within the user interface in response to a third input associated with the first user interface element.

In some embodiments, the method 800 may include, in response to receiving, by the computing system, a selection of a geographic element of the set of geographic elements, determining, by the computing device, one or more videos associated with the selected geographic element to include in the video stream. In some aspects, the selected geographic element may represent a location. Further, wherein determining, by the computing device, one or more videos associated with the selected geographic element to include in the video stream may include analyzing metadata of each of the one or more videos, wherein the metadata of each respective video of the one or more videos may represent the location. In some aspects, the location may represent where each of the one or more videos was recorded.

In some embodiments, a geographic element of the set of geographic elements may represent a location of the computing device. Further, in some embodiments, the method 800 may include, in response to receiving, by the computing device, a selection of the geographic element representing the location of the computing device, determining, by the computing device, one or more videos associated with the selected geographic element to include in the video stream. In some aspects, each of the one or more videos associated with the selected geographic element was recorded within a threshold distance of the location of the computing device.

As shown in FIG. 8, the method 800 may further include generating, using the computing device, a second user interface element including a set of interest elements, wherein each of the set of interest elements represents a respective selectable filter, wherein only a subset of the set of interest elements is configured to be presented in the user interface at a time, wherein the set of interest elements is configured to rotate in the first direction within the user interface in response to a second input associated with the second user interface element, and wherein the second user interface element is configured to be positioned proximate to the first user interface element in the user interface (804). In some aspects, the set of interest elements may be configured to rotate in the second direction within the user interface in response to a fourth input associated with the second user interface element. The method 800 may include determining, using the computing device, an order in which the subset of the set of interest elements is to be presented in the user interface based on usage behavior of a user associated with the computing device. Further, the method 800 may include, in response to receiving, by the computing device, a selection of an interest element of the set of interest elements, determining, by the computing device, one or more videos associated with the selected interest element to include in the video stream.

In some embodiments, the method 800 may include determining, using the computing device, an ordering of a plurality of videos to include in the video stream based on a score for each respective video of the plurality of videos. In some aspects, the score for a respective video of the plurality of videos may be determined based on one or more of a rating of the respective video, a number of times the respective video has been shared, or a number of times the respective video has been viewed. Further, in some embodiments, the method 800 may include, in response to receiving, by the computing device, a selection of a geographic element of the set of geographic elements and a selection of an interest element of the set of interest elements, determining, by the computing device, one or more videos associated with the selected geographic element and the selected interest element to include in the video stream.

Although FIG. 8 illustrates the first user interface element to include a set of geographic elements and the second user interface element to include a set of interest elements as an exemplary embodiment, the set of elements included in each of the first user interface element and the second user interface element may include any attribute representative of a respective category, class, topic, entity, or the like, as discussed above with respect to FIG. 5.

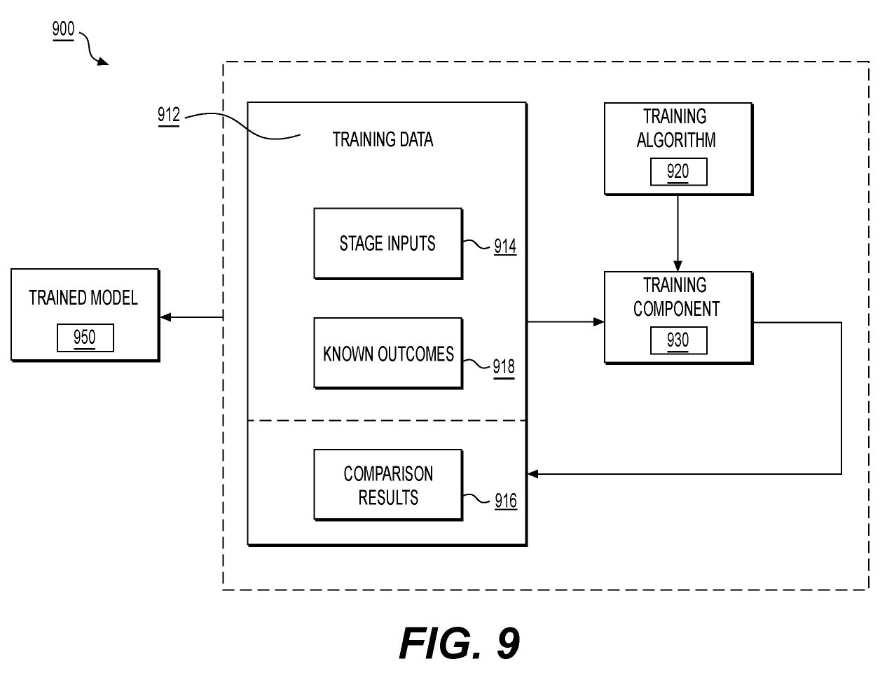

FIG. 9 depicts a flow diagram for training a machine learning model, in accordance with one or more embodiments. As shown in flow diagram 900 of FIG. 9, training data 912 may include one or more of stage inputs 914 and known outcomes 918 related to a machine learning model to be trained. The stage inputs 914 may be from any applicable source including a component or set shown in the figures provided herein. The known outcomes 918 may be included for machine learning models generated based on supervised or semi-supervised training. An unsupervised machine learning model might not be trained using known outcomes 918. Known outcomes 918 may include known or desired outputs for future inputs similar to or in the same category as stage inputs 914 that do not have corresponding known outputs.

The training data 912 and a training algorithm 920 may be provided to a training component 930 that may apply the training data 912 to the training algorithm 920 to generate a trained machine learning model 950. According to an implementation, the training component 930 may be provided comparison results 916 that compare a previous output of the corresponding machine learning model to apply the previous result to re-train the machine learning model. The comparison results 916 may be used by the training component 930 to update the corresponding machine learning model. The training algorithm 920 may utilize machine learning networks or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, or discriminative models such as Decision Forests and maximum margin methods, or the like. The output of the flow diagram 900 may be a trained machine learning model 950.

A machine learning model disclosed herein may be trained by adjusting one or more weights, layers, or biases during a training phase. During the training phase, historical or simulated data may be provided as inputs to the model. The model may adjust one or more of its weights, layers, or biases based on such historical or simulated information. The adjusted weights, layers, or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

In general, any process or operation discussed in this disclosure that is understood to be computer-implementable, such as the processes or operations illustrated in FIGS. 1-8, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

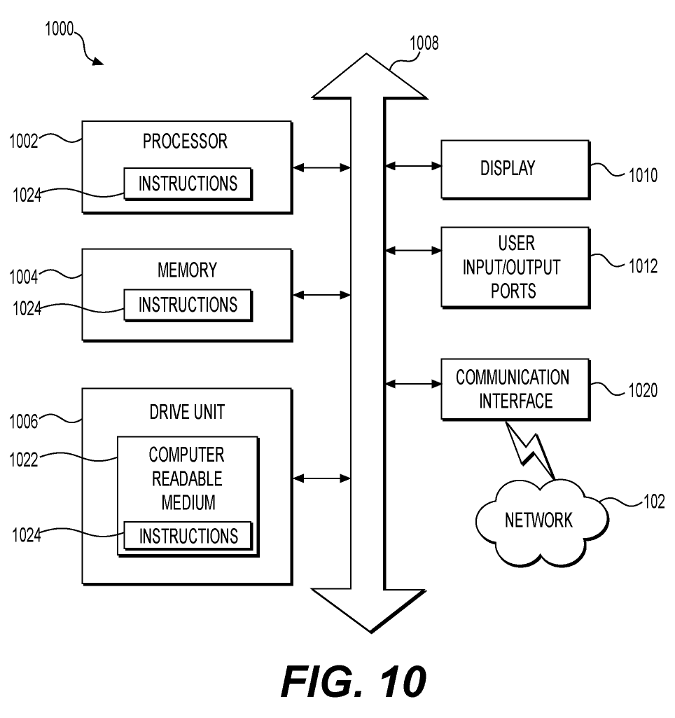

FIG. 10 is a simplified functional block diagram of a computer 1000 that may be configured as a device for executing any of the processes, operations, or methods of FIGS. 1-9, according to exemplary embodiments of the present disclosure. In various embodiments, any of the devices or systems herein may be a computer 1000 including, for example, a data communication interface 1020 for packet data communication. The computer 1000 also may include a central processing unit (“CPU”) 1002, in the form of one or more processors, for executing program instructions. The computer 1000 may include an internal communication bus 1008, and a storage unit 1006 (such as ROM, HDD, SDD, etc.) that may store data on a computer readable medium 1022, although the computer 1000 may receive programming and data via network communications. The computer 1000 may also have a memory 1004 (such as RAM) storing instructions 1024 for executing techniques presented herein, although the instructions 1024 may be stored temporarily or permanently within other modules of computer 1000 (e.g., processor 1002 or computer readable medium 1022). The computer 1000 also may include input and output ports 1012 or a display (or display screen) 1010 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method comprising:
generating, using a computing device, a first user interface element including a set of geographic elements, wherein each of the set of geographic elements represents a respective selectable filter, wherein only a subset of the set of geographic elements is configured to be presented in a user interface at a time, and wherein the set of geographic elements is configured to rotate in a first direction within the user interface in response to a first input associated with the first user interface element; and
generating, using the computing device, a second user interface element including a set of interest elements, wherein each of the set of interest elements represents a respective selectable filter, wherein only a subset of the set of interest elements is configured to be presented in the user interface at a time, wherein the set of interest elements is configured to rotate in the first direction within the user interface in response to a second input associated with the second user interface element, and wherein the second user interface element is configured to be positioned proximate to the first user interface element in the user interface.

2. The method of claim 1, wherein the user interface is configured to include a video stream, and wherein the method further comprises:
in response to receiving, by the computing device, a selection of a geographic element of the set of geographic elements, determining, by the computing device, one or more videos associated with the selected geographic element to include in the video stream.

3. The method of claim 2, wherein the selected geographic element represents a location, and wherein determining, by the computing device, one or more videos associated with the selected geographic element to include in the video stream comprises:
analyzing metadata of each of the one or more videos, wherein the metadata of each respective video of the one or more videos represents the location.

4. The method of claim 3, wherein the location represents where each of the one or more videos was recorded.

5. The method of claim 1, wherein a geographic element of the set of geographic elements represents a location of the computing device.

6. The method of claim 5, wherein the user interface is configured to include a video stream, and wherein the method further comprises:
in response to receiving, by the computing device, a selection of the geographic element representing the location of the computing device, determining, by the computing device, one or more videos associated with the selected geographic element to include in the video stream.

7. The method of claim 6, wherein each of the one or more videos associated with the selected geographic element was recorded within a threshold distance of the location of the computing device.

8. The method of claim 1, wherein the user interface is configured to include a video stream, and wherein the method further comprises:
determining, using the computing device, an ordering of a plurality of videos to include in the video stream based on a score for each respective video of the plurality of videos.

9. The method of claim 8, wherein the score for a respective video of the plurality of videos is determined based on one or more of a rating of the respective video, a number of times the respective video has been shared, or a number of times the respective video has been viewed.

10. The method of claim 1, further comprising:
determining, using the computing device, an order in which the subset of the set of interest elements is to be presented in the user interface based on usage behavior of a user associated with the computing device.

11. The method of claim 1, wherein the user interface is configured to include a video stream, and wherein the method further comprises:
in response to receiving, by the computing device, a selection of an interest element of the set of interest elements, determining, by the computing device, one or more videos associated with the selected interest element to include in the video stream.

12. The method of claim 1, wherein the user interface is configured to include a video stream, and wherein the method further comprises:
in response to receiving, by the computing device, a selection of a geographic element of the set of geographic elements and a selection of an interest element of the set of interest elements, determining, by the computing device, one or more videos associated with the selected geographic element and the selected interest element to include in the video stream.

13. The method of claim 1, wherein the set of geographic elements is configured to rotate in a second direction, opposite the first direction, within the user interface in response to a third input associated with the first user interface element; and wherein the set of interest elements is configured to rotate in the second direction within the user interface in response to a fourth input associated with the second user interface element.

14. A computing system, comprising:
one or more processors; and
one or more non-transitory computer readable media having programming instructions stored thereon, which, when executed by the one or more processors, cause the computing system to perform operations comprising:
generating a first user interface element including a set of geographic elements, wherein each of the set of geographic elements represents a respective selectable filter, wherein only a subset of the set of geographic elements is configured to be presented in a user interface at a time, and wherein the set of geographic elements is configured to rotate in a first direction within the user interface in response to a first input associated with the first user interface element; and
generating a second user interface element including a set of interest elements, wherein each of the set of interest elements represents a respective selectable filter, wherein only a subset of the set of interest elements is configured to be presented in the user interface at a time, wherein the set of interest elements is configured to rotate in the first direction within the user interface in response to a second input associated with the second user interface element, and wherein the second user interface element is configured to be positioned proximate to the first user interface element in the user interface.

15. The computing system of claim 14, wherein the user interface is configured to include a video stream, and wherein the operations further comprise:
in response to receiving a selection of a geographic element of the set of geographic elements, determining one or more videos associated with the selected geographic element to include in the video stream.

16. The computing system of claim 15, wherein the selected geographic element represents a location, and wherein determining one or more videos associated with the selected geographic element to include in the video stream comprises:
analyzing metadata of each of the one or more videos, wherein the metadata of each respective video of the one or more videos represents the location.

17. The computing system of claim 16, wherein the location represents where each of the one or more videos was recorded.

18. The computing system of claim 14, wherein a geographic element of the set of geographic elements represents a location of the computing system.

19. The computing system of claim 18, wherein the user interface is configured to include a video stream, and wherein the operations further comprise:
in response to receiving a selection of the geographic element representing the location of the computing system, determining one or more videos associated with the selected geographic element in the video stream.

20. A computer-implemented method comprising:
generating, using a computing system, a user interface element including a set of geographic elements, wherein each of the set of geographic elements represents a respective selectable filter, wherein only a subset of the set of geographic elements is configured to be presented in a user interface at a time, and wherein the set of geographic elements is configured to rotate in a direction within the user interface in response to an input associated with the user interface element, the user interface being configured to include a video stream; and
in response to receiving, by the computing system, a selection of a geographic element of the set of geographic elements, determining, by the computing system, one or more videos associated with the selected geographic element to present in the video stream.
